(19) United States
(12) Patent Application Publication
(10) Pub. No.: US 2005/0198857 A1
(43) Pub. Date: Sep. 15, 2005

(54) Apparatus and method for removing organic contamination adsorbed onto substrate, and apparatus and method for measuring thickness of thin film formed on substrate

(75) Inventors: Yoshiyuki Nakazawa, Kyoto (JP); Motohiro Kono, Kyoto (JP); Toshikazu Kitajima, Kyoto (JP); Daisuke Iso, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/069,995

(22) Filed: Mar. 3, 2005

(30) Foreign Application Priority Data
Mar. 10, 2004 (JP) P2004-66528
Apr. 19, 2004 (JP) P2004-122416

(51) Int. Cl. F26B 7/00; F26B 19/00

(52) U.S. Cl. 34/391; 34/60

(57) ABSTRACT

In a body of a film-thickness measuring apparatus (1), an organic contamination remover (3) for removing organic contamination adsorbed onto a substrate (9) is provided. The organic contamination remover (3) includes a chamber body (31), an interior of which is kept clean. In the chamber body (31), a hot plate (32) for heating the substrate, a cooling plate (33) for cooling the substrate, and a transfer arm (34) for moving the substrate (9) from the hot plate (32) to the cooling plate (33) in the chamber body 31, are provided. With this structure, it is possible to keep the substrate (9) in a clean atmosphere within the chamber body (31), to thereby suppress re-adsorption of organic contamination onto the substrate during a time period from a time when organic contamination adsorbed onto the substrate (9) is removed to a time when cooling is completed.

### BACKGROUND OF THE INVENTION

1. Field of the Invention

The present invention relates to an apparatus and a method for removing organic contamination adsorbed onto a substrate, and more particularly to a technique for measuring a thickness of a thin film formed on a substrate.

2. Description of the Background Art

In recent years, as a circuit pattern of a semiconductor product has become finer based on a scaling law, a thickness of a film formed on a semiconductor substrate (which will hereinafter be referred to as a “substrate”) in semiconductor manufacturing processes has become smaller. It is expected that a film thickness of silicon oxide (SiO₂) serving as a gate insulator is equal to or smaller than 1 nm for 65-nm technology node (i.e., a node length), for example, in the future.

On the other hand, it is well known that an optical measurement value of a film thickness is increased due to exposure of a substrate to an atmospheric air in a clean room or storage in a substrate container. This phenomenon is considered to be caused due to adsorption of organic contamination which is produced due to gas released from a plastic material or the like, onto a surface of the substrate. For example, it was confirmed that in a case where a substrate on which a film of silicon oxide with a thickness of 9.2 nm (p-type silicon (Si) substrate) is formed is stored in a substrate container for ten days, the thickness as measured after the storage is increased by approximately 0.2 nm. As such, as a film is becoming further thinner, increase in the thickness due to organic contamination shall more significantly affect process control of semiconductor manufacturing processes. It is additionally noted that though to employ a material which releases little gas as a substrate container for storing a substrate, or to provide a chemical filter, might be of some help to suppression of adsorption of organic contamination onto the substrate, it is difficult to completely eliminate released gas by the foregoing solutions.

In view of this, suggested is an apparatus for removing organic contamination adsorbed onto a substrate by heating the substrate prior to measuring a thickness of a film on the substrate, in order to accurately measure the thickness of the film. For example, Published Japanese translation of a PCT application No. 2002-501305 teaches an apparatus for removing organic contamination adsorbed onto a substrate, which applies light to the substrate supported by support pins within a chamber, to heat the substrate. Also, the specification of U.S. Pat. No. 6,261,853 discloses an apparatus for removing organic contamination, which is capable of efficiently cooling a substrate after heating the substrate by including a chamber for heating and a chamber for cooling which are thermally separated from each other. Further, there is another known method for removing organic contamination, which utilizes ultraviolet rays or ozone. However, this method has the possibility of deteriorating a film formed on a substrate.

In the meantime, in the apparatus for removing organic contamination taught by Published Japanese translation of the PCT application No. 2002-501305, both heating of the substrate and cooling of the substrate are accomplished on the same support pins. Hence, required processes cannot be efficiently performed. On the other hand, in the apparatus for removing organic contamination disclosed by the specification of U.S. Pat. No. 6,261,853, required processes can be efficiently performed because of provision of a hot plate and a cooling plate. Nonetheless, after a substrate is heated, the substrate must be taken out of the chambers so that the substrate can be transferred from the chamber for heating to the chamber for cooling. This increases the possibility that organic contamination will be again adsorbed onto the substrate.

### SUMMARY OF THE INVENTION

The present invention is directed to an apparatus for removing organic contamination adsorbed onto a substrate, and it is an object of the present invention to suppress re-adsorption of organic contamination after organic contamination is removed from a substrate.

According to one aspect of the present invention, an apparatus comprises a hot plate for heating a substrate, a cooling plate for cooling the substrate, a transfer mechanism for moving a substrate from the hot plate to the cooling plate, and a chamber body in which the hot plate and the cooling plate are provided, which includes a transfer path of a substrate from the hot plate to the cooling plate.

Since the transfer path of a substrate from the hot plate to the cooling plate is included in the chamber body in the foregoing apparatus, it is possible to suppress re-adsorption of organic contamination during a time period from a time when organic contamination adsorbed onto a substrate is removed to a time when cooling of a substrate is completed.

Preferably, each of the hot plate and the cooling plate is in a horizontal state, and the hot plate and the cooling plate are arranged along a horizontal state in the foregoing apparatus. This makes it possible to easily move a substrate from the hot plate to the cooling plate.

According to a preferred embodiment of the present invention, the transfer mechanism is provided in the chamber body, the chamber body comprises only one opening through which a substrate passes, and a substrate is once received by the cooling plate when the substrate is transferred from and to the chamber body. This can simplify the structure of the apparatus.

According to another preferred embodiment of the present invention, the chamber body comprises an opening through which a substrate is transferred to the hot plate and another opening through which a substrate is transferred from the cooling plate.

The present invention is also directed to an apparatus for measuring a thickness of a thin film formed on a substrate. The apparatus for measuring a thickness of a thin film comprises an organic contamination remover corresponding to the foregoing apparatus for removing organic contamination adsorbed onto a substrate, and a film-thickness measuring part for measuring a film thickness on a substrate after organic contamination is removed from the substrate by the organic contamination remover. Preferably, the film thickness measuring part is an ellipsometer. Since re-adsorption of organic contamination is suppressed, it is possible to accurately measure a thickness of a thin film on a substrate.

The present invention is also directed to a method of removing organic contamination adsorbed onto a substrate and a method of measuring a thickness of a thin film formed of a substrate.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view of a film-thickness measuring apparatus according to a first preferred embodiment;

FIG. 2 illustrates an internal structure of a film-thickness measuring apparatus according to the first preferred embodiment;

FIGS. 3 and 4 illustrate an internal structure of an organic contamination remover;

FIG. 5 is a flow chart illustrating operations for removing organic contamination and measuring a thickness of a thin film on a substrate;

FIG. 6 illustrates a film-thickness measuring apparatus according to a second preferred embodiment;

FIG. 7 illustrates a film-thickness measuring apparatus according to a third preferred embodiment;

FIG. 8 is a diagrammatic view of a structure of an organic contamination remover;

FIG. 9 illustrates a film-thickness measuring apparatus according to a fourth preferred embodiment;

FIG. 10 illustrates an internal structure of an organic contamination remover of a film-thickness measuring apparatus according to a fifth preferred embodiment;

FIG. 11 illustrates an internal structure of an organic contamination remover; and

FIG. 12 is a flow chart illustrating operations for removing organic contamination.

### DESCRIPTION OF THE PREFERRED EMBODIMENTS

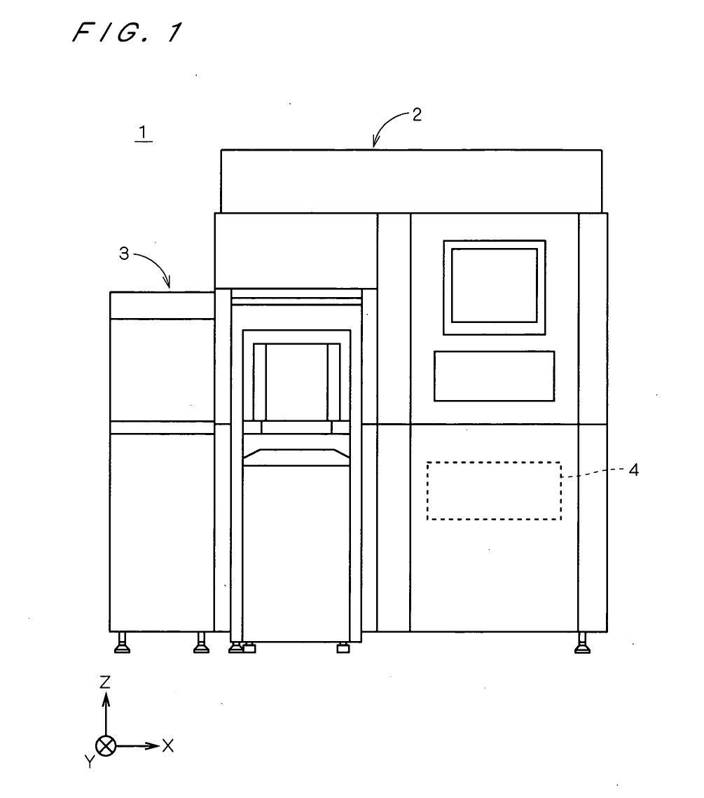

FIG. 1 is a front view of a film-thickness measuring apparatus 1 according to a first preferred embodiment of the present invention. As illustrated in FIG. 1, a body 2 of the film-thickness measuring apparatus 1 is provided with an organic contamination remover 3 for removing (or desorbing) organic contamination adsorbed onto (or adhering to) a substrate. Also, a control unit 4 allocated to overall control of the film-thickness measuring apparatus 1 is provided under the body 2. In the film-thickness measuring apparatus 1, a thickness of a thin film (or thin films) (an oxide film, for example) formed on a substrate is measured by constituent elements in the body 2 after organic contamination adsorbed onto the substrate is removed by the organic contamination remover 3. Below, the body 2 and the organic contamination remover 3 will be described in detail.

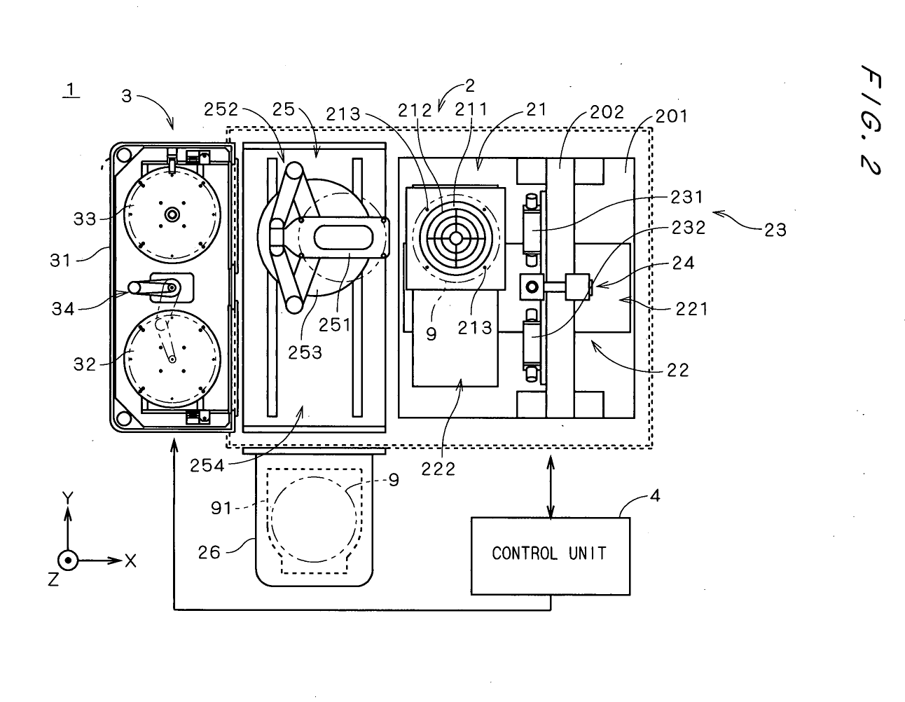

FIG. 2 illustrates an internal structure of the film-thickness measuring apparatus 1. It is noted that hatching lines for a sectional view of a chamber body 31 of the organic contamination remover 3 which will be later described are omitted in FIG. 2.

On a surface plate 201 provided in the body 2, a stage 21 for holding a substrate 9 and a stage moving mechanism 22 for moving the stage 21 in an X direction and a Y direction shown in FIG. 2 are provided. Also, a frame 202 is secured onto the surface plate 201 so as to extend across the stage moving mechanism 22. Further, an ellipsometer 23 for applying a polarized light to the substrate 9 and obtaining a polarized state of a reflected light received from the substrate 9, and an interferometer unit 24 for applying an illumination light to the substrate 9 and obtaining a spectral intensity of a reflected light received from the substrate 9, are attached to the frame 202.

The stage 21 includes a disc-like substrate holder 211 for holding the substrate 9 and a stage turning mechanism (not illustrated) for turning the substrate holder 211. Grooves 212 used for suction of the substrate 9 is formed in a surface of the substrate holder 211. Further, a plurality of lift pins 213 for moving the substrate 9 in a Z direction shown in FIG. 2 are provided outside the substrate holder 211 in the stage 21. The stage moving mechanism 22 includes an X-direction moving mechanism 221 and a Y-direction moving mechanism 222 each including a motor, and the substrate 9 on the stage 21 is moved relative to the ellipsometer 23 and the interferometer unit 24 by the stage moving mechanism 22.

The ellipsometer 23 includes a light source unit 231 for emitting a polarized light toward the substrate 9 and a light receiving unit 232 for receiving a reflected light from the substrate 9 and obtaining a polarized state of the reflected light. The light source unit 231 includes a semiconductor laser (LD) for emitting a light beam and a polarizer serving as a polarization element. A light beam emitted from the semiconductor laser is polarized by the polarizer, and a polarized light is applied to the substrate 9. The light receiving unit 232 includes an analyzer serving as a polarization element. The analyzer rotates around an axis parallel to an optical axis. A reflected light of the polarized light which is received from the substrate 9 is guided to the analyzer which is rotating, and a light transmitted through the analyzer is received by a photodiode. Then, the ellipsometer 23 obtains a polarized state of the reflected light based on an output of the photodiode which is related to a rotation angle of the analyzer. Then, the obtained polarized state is output to the control unit 4. It is additionally noted that a structure of the ellipsometer 23 is not limited to the above-described structure. Alternatively, the polarizer may rotate, for example.

The interferometer unit 24 includes a light source for emitting a white light, which is applied to the surface of the substrate 9 through an optical system. A reflected light received from the substrate 9 is guided to a spectroscope by the optical system. Then, a spectral intensity of the reflected light is obtained, and output to the control unit 4.

The control unit 4 includes a circuit for controlling the body 2 and the organic contamination remover 3, and further includes a calculator for calculating a thickness of a thin film on the substrate 9 based on the polarized state of the reflected light which is input from the ellipsometer 23 or the spectral intensity of the reflected light which is input form the interferometer unit 24. In the following description, it is assumed that a film thickness is obtained using the ellipsometer 23 which is capable of measuring a smaller film-thickness than the interferometer unit 24. However, a film thickness may alternatively be obtained using the interferometer unit 24 as needed.

In the body 2, a transfer robot 25 is provided between the stage 21 and the organic contamination remover 3. Also, a pod opener 26 for opening and closing a pod 91 (a FOUP (Front-Opening Unified Pod), for example) in which the substrate is housed is provided in the (−Y) direction relative to the transfer robot 25. In the transfer robot 25, a board 251 is attached to an end of an extendable arm 252, and the substrate 9 is to be placed on the board 251. The arm 252 is secured to a turning mechanism 253. The turning mechanism 253 is moved in the Y direction by a moving mechanism 254. The transfer robot 25 has an access to each of the stage 21, the organic contamination remover 3, and the pod opener 26. The pod 91 is opened by the pod opener 26, and then the substrate 9 in the pod 91 is taken out by the transfer robot 25, to be loaded into the film-thickness measuring apparatus 1. Also, after a film thickness of the substrate 9 is measured, the substrate 9 is returned back into the pod 91 by the transfer robot 25, to be unloaded from the film-thickness measuring apparatus 1.

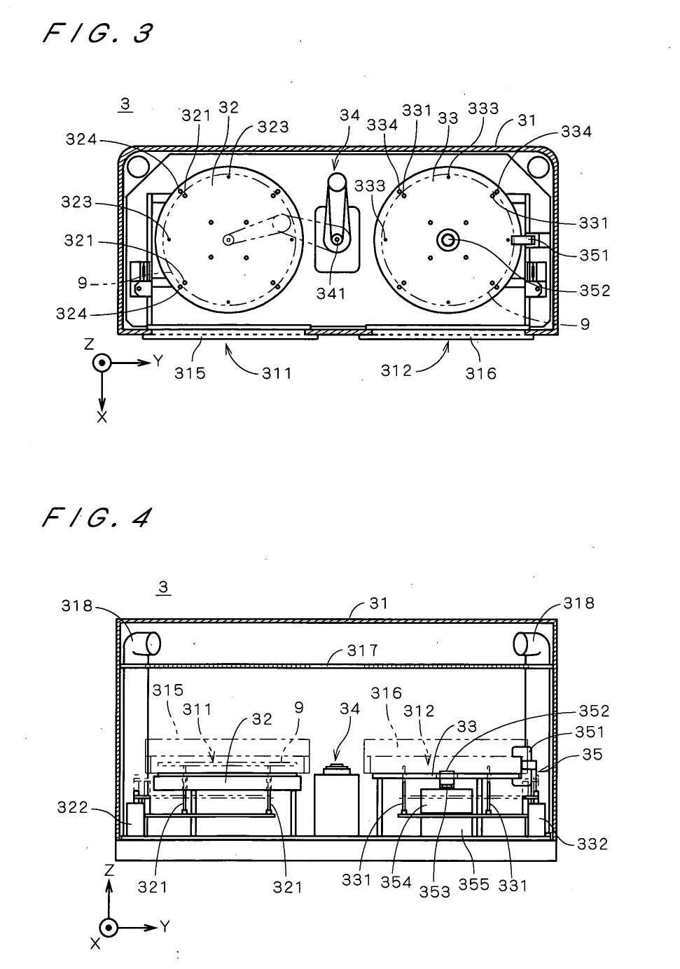

FIG. 3 is a magnified view of the organic contamination remover 3. As illustrated in FIG. 3, the organic contamination remover 3 includes the chamber body 31 which forms a space for processing the substrate 9. In the chamber body 31, a disc-like hot plate 32 for heating the substrate 9 (at a temperature in the range of 200° C. to 420° C., more preferably, in the range of 300° C. to 350° C.) using a heater provided therein, and a circular thin cooling plate which is made of aluminum and functions to cool the substrate (at a temperature in the range of 10° C. to 40° C., for example), are arranged along the Y direction. Also, a transfer arm 34 for transferring the substrate 9 from the hot plate 32 to the cooling plate 33 is provided between the hot plate 32 and the cooling plate 33. At an end of the transfer arm 34, a chuck 341 for holding the substrate 9 by the sucking force is formed. It is additionally noted that though cooling of the substrate 9 is achieved by placing the substrate 9 on the cooling plate 33 made of aluminum which has a high thermal conductivity in the first preferred embodiment, a water cooling mechanism or an air cooling mechanism may be provided in the cooling plate 33 as needed (for example, it is preferable to provide a Peltier device on a back surface of the cooling plate 33 to cool the substrate). Also, the cooling plate 33 may be made of a material other than aluminum.

On a surface of the hot plate 32, a plurality of ceramic balls 323 are arranged at regular intervals along a circle having a diameter which is a little bit smaller than a diameter of a circumference of the substrate 9. Because of provision of the plurality of ceramic balls 323, a small clearance (what is called a “proximity gap”) is formed between the substrate 9 placed on the hot plate 32 and the surface of the hot plate 32. Accordingly, it is possible to uniformly heat the substrate 9 and to suppress adhesion of unnecessary substances such as particles to a back surface of the substrate 9 (a main surface facing the hot plate 32). In an analogous manner, a plurality of ceramic balls 333 are provided on the cooling plate 33. Accordingly, it is possible to uniformly cool the substrate 9 and to suppress adhesion of particles or the like to the back surface of the substrate 9. Further, a plurality of guiding members 324 and a plurality of guiding members 334 each for preventing shift of the substrate 9 are provided in the hot plate 32 and the cooling plate 33, respectively.

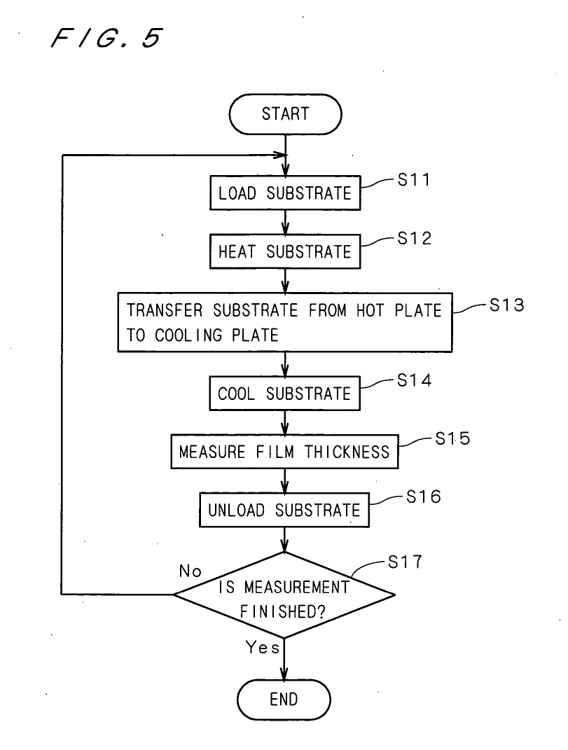

FIG. 4 illustrates an internal structure of the organic contamination remover 3 when viewed from the (+X) side to the (−X) direction. It is noted that FIG. 4 illustrates a state in which a portion of the chamber body 31 which is close to the body 2 is taken out.

As illustrated in FIG. 4, the hot plate 32 and the cooling plate 33 each in a horizontal state are arranged at substantially the same level. A pin moving mechanism 322 connected to a plurality of lift pins 321 and including a cylinder are provided in the vicinity of the hot plate 32. The plurality of lift pins 321 are moved in the Z direction by the pin moving mechanism 322. In the hot plate 32, a plurality of through holes are formed in positions respectively facing the plurality of lift pins 321. Then, the substrate 9 on the hot plate 32 is moved in the Z direction by the plurality of lift pins 321. Also, a pin moving mechanism 332 connected to a plurality of lift pins 331 and including a cylinder are provided in the vicinity of the cooling plate 33, and the plurality of lift pins 331 are moved in the Z direction by the pin moving mechanism 332 in the same manner as described above regarding the hot plate 32. Further, in the cooling plate 33, a plurality of through holes are formed in positions facing the plurality of lift pins 331, and the substrate 9 on the cooling plate 33 are lifted up by the plurality of lift pins 331.

The cooling plate 33 is further provided with a centering unit 35 for adjusting a location of the substrate 9. The centering unit 35 includes an edge detection sensor 351 for detecting a location of an edge of the substrate 9, a chuck 352 for holding the substrate 9 by vacuum, a turning mechanism 353 for turning the chuck 352, an elevating mechanism 354 for moving upward and downward the chuck 352, and a slightly-moving mechanism 355 for slightly moving the chuck 352 in the X direction and the Y direction. In the cooling plate 33, the chuck 352 turns the substrate 9 while holding the substrate 9, so that an edge and a notch (or an orientation flat) of the substrate 9 are detected by the edge detection sensor 351. As a result, a location of a center of the substrate 9 and an orientation of the notch of the substrate 9 are specified, and the slightly-moving mechanism 355 and the turning mechanism 353 are controlled such that the substrate 9 is centered and the notch is oriented in a predetermine direction.

In a (+X) part of the chamber body 31 (closer to the body 2) relative to the other parts (which will be hereinafter referred to as “(+X) side”), two openings 311 and 312 arranged along the Y direction are provided (the openings 311 and 322 are indicated by double-dashed lines in FIG. 4). The opening 311 located in the (−Y) direction relative to the opening 312 is formed in the vicinity of the hot plate 32, and the substrate 9 passes through the opening 311 when the substrate 9 is transferred to the hot plate 32 by the transfer robot 25 (see FIG. 2). The opening 312 located in the (+Y) direction relative to the opening 311 is formed in the vicinity of the cooling plate 33, and the substrate 9 passes through the opening 312 when the substrate 9 is transferred from the cooling plate 33.

Further, two shutters (not illustrated) for opening and closing the openings 311 and 312, respectively, are provided in the chamber body 31. The two shutters operate in synchronization with the pin moving mechanism 322 and 332, respectively. Specifically, when the pin moving mechanism 322 moves upward the lift pins 321, the opening 311 is opened. On the other hand, when the pin moving mechanism 332 moves upward the lift pins 331, the opening 312 is opened. However, the shutters are not necessarily required to operate in synchronization with the pin moving mechanism 322 and 332. It is sufficient that the shutters open the openings 311 and 321 with suitable timings.

Moreover, in the chamber body 31, nozzles 315 and 316 each including a slit nozzle for ejecting downward predetermined gas (nitrogen gas, or a clean air, for example) are provided above the openings 311 and 312, respectively (in other words, on the (+Z) sides of the openings 311 and 312, respectively). Each of the nozzles 315 and 316 purges an interior of the chamber body 31 using the predetermined gas to keep the interior of the chamber body 31 clean. Also, since the nozzles 315 and 316 eject the gas near peripheries of the openings 311 and 312 along a surface in which the openings 311 and 312 are formed, respectively, the nozzles 315 and 316 also function as air curtains for preventing an external air from flowing into the chamber body 31 while openings 311 and 312 are opened. As a result, external organic contamination is prevented from entering into the chamber body 31 at the time of transferring the substrate 9 to and from the chamber body 31, to thereby prevent reduction of cleanness within the chamber body 31. Additionally, further nozzles for ejecting upward gas may be provided under the openings 311 and 312, respectively. Also, a gas supplier for purging an interior of the chamber body 31 may be additionally provided in the organic contamination remover 3. In this case, it is preferable to attach the gas supplier so as to allow gas to flow from the cooling plate 33 to the hot plate 32, because to do so prevents reduction of an efficiency in cooling the substrate 9 in the cooling plate 33, which is likely to reduce due to heat of the hot plate 32.

As illustrated in FIG. 4, an upper cover 317 including a net-like vent is provided in an upper part of the chamber body 31. Gas flowing into a space above the upper cover 317, which is formed between the upper cover 317 and the chamber body 31, is let out by an exhausting mechanism including a pump (not illustrated) and exhaust pipes 318 connected to the pump. As such, gas within the chamber body 31 which is heated by the hot plate 32 is efficiently let out (i.e., exhausted) by the exhausting mechanism, so that increase of a temperature of an ambient air within the chamber body 31 can be prevented. Also, to provide the exhaust pipes 318 above the chamber body 31 can reduce a footprint of the organic contamination remover 3.

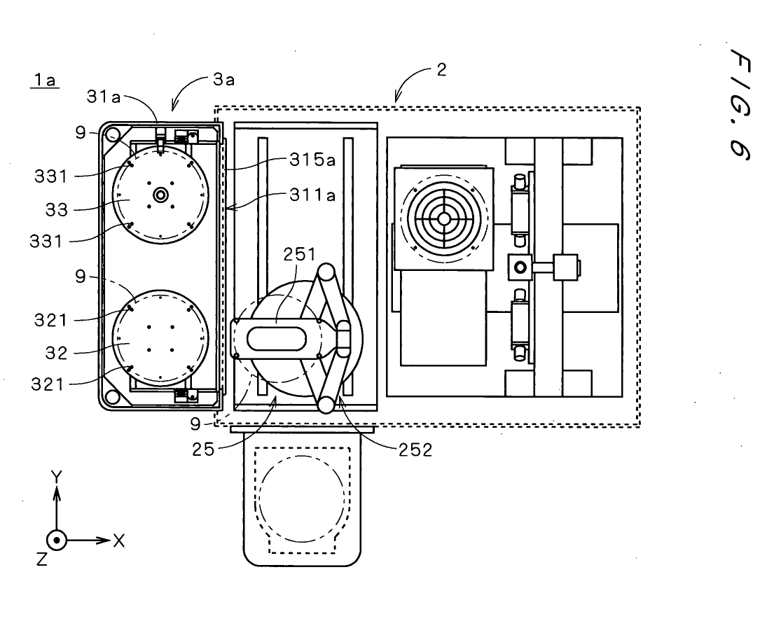

FIG. 5 is a flow chart illustrating operations of the film-thickness measuring apparatus 1 for removing organic contamination adsorbed onto the substrate 9 and measuring a thickness of a thin film on the substrate 9 from which the organic contamination has been removed. In the film-thickness measuring apparatus 1, first, the pod 91 placed in the pod opener 26 is opened, and then, one of the substrates 9 prepared as targets of measurement is loaded into the film-thickness measuring apparatus 1 by the transfer robot 25 (step S11). The substrate 9 loaded into the film-thickness measuring apparatus 1 is moved to a position facing the opening 311 in the chamber body 31 illustrated in FIG. 3 by the transfer robot 25. Subsequently, the shutter is opened in synchronization with upward movement of the plurality of lift pins 321, and also, the arm 252 extends in the (−X) direction so that the substrate 9 on the board 251 is transferred into the chamber body 31. When the substrate 9 is placed above the hot plate 32, the plurality of lift pins 321 move further upward, so that the substrate 9 is held by the lift pins 321. Then, the lift pins 321 move downward, so that the substrate 9 is placed on the hot plate 32. While the substrate 9 is being placed on the hot plate 32, the back surface of the substrate 9 is heated at a predetermined temperature for a predetermined time period (at 340° C. for three minutes, for example), to remove organic contamination adsorbed onto the substrate 9 (step S12). After being removed from the substrate 9, the organic contamination, together with an ambient gas, is let out from the exhaust pipes 318. As a result, the interior of the chamber body 31 is kept clean, and re-adsorption of organic contamination onto the substrate 9 is suppressed.

After the substrate 9 is heated, the substrate 9 is moved upward by the plurality of lift pins 321, and the chuck 341 of the transfer arm 34 is placed below the substrate 9. Subsequently, the lift pins 321 move downward, so that the substrate 9 is held by the chuck 341. Then, the transfer arm 34 moves the substrate 9 to a position above the cooling plate 33, where the plurality of lift pins 331 lift up the substrate 9. After the chuck 341 is withdrawn, the lift pins 331 move downward, so that the substrate 9 is placed on the cooling plate 33 (step S13). As is made clear from the above description, a transfer path of the substrate 9 from the hot plate 32 to the cooling plate 33 is included within the chamber body 31 in the organic contamination remover 3. Accordingly, re-adsorption of organic contamination onto the substrate 9 during movement of the substrate 9 is suppressed. Also, the transfer arm 34 for transferring the substrate 9 is included in the chamber body 31. This makes it possible to keep the cleanness of the interior of the chamber body 31 constant. Further, the hot plate 32 and the cooling plate 33 each in a horizontal state are arranged side by side along a horizontal direction. This allows the transfer arm 34 to easily transfer the substrate 9 from the hot plate 32 to the cooling plate 33 while preventing the substrate 9 from being unnecessarily moved upward and downward by the lift pins 321 or the lift pins 331.

While the substrate 9 is being placed on the cooling plate 33, the back surface of the substrate 9 which has been heated by the hot plate 32 is cooled for a predetermined time period (step S14). If a thickness of a thin film on the substrate 9 is measured with the substrate 9 being kept at a high temperature, it is impossible to accurately measure the thickness because optical constants of the thin film at such high temperature are different from that at a normal temperature. However, since the substrate 9 is cooled by the cooling plate 33, the thickness of the thin film can be measured accurately and rapidly in a later process.

Then, the chuck 352 moves upward to hold the substrate 9. Further, the chuck 352 turns while holding the substrate 9, to allow the edge detection sensor 351 to detect the edge of the substrate 9. In this manner, the substrate 9 is centered and an orientation of the notch of the substrate 9 is adjusted. At that time, the location of the substrate 9 is adjusted by the centering unit 35 while the substrate 9 is naturally cooled. As such, operations for measuring the film thickness can be performed efficiently. After the location of the substrate 9 is adjusted, the substrate 9 is lifted up by the lift pins 331 and is transferred from the cooling plate 33 through the opening 312 on the (+Y) side of the chamber body 31 by the transfer robot 25. During transfer from the cooling plate 33, gas having a lower temperature than the substrate 9 is ejected from the nozzle 316 toward the substrate 9 which is passing through the opening 312, to further cool the substrate 9. After the substrate 9 is transferred from the chamber body 31 by the transfer robot 25, the substrate 9 is placed on the plurality of lift pins 213 of the stage 21 illustrated in FIG. 2, and thereafter, the lift pins 213 move downward, so that the substrate 9 is held by the substrate holder 211.

The substrate 9 is shifted by the stage moving mechanism 22, and a predetermined measuring point on the substrate 9 is aligned with a position to which a polarized light is applied by the ellipsometer 23. For the alignment at that time, since the location and the orientation of the substrate 9 are previously adjusted by the centering unit 35, the substrate 9 can be accurately aligned with the ellipsometer 23. Thereafter, the ellipsometer 23 applies a polarized light to the substrate 9, and a reflected light is received from the substrate 9. Then, a polarized state of the reflected light is obtained. The calculator in the control unit 4 calculates a film thickness at the measuring point of the substrate 9 based on the polarized state and data which has been previously prepared (step S15). As is made clear from the above description, the ellipsometer 23 and the calculator in the control unit 4 form a film-thickness measuring part for measuring a thickness of a film on the substrate 9 from which organic contamination has been removed, in the film-thickness measuring apparatus 1.

Actually, a plurality of measuring points are set up on the substrate 9. After a film thickness at one of the measuring points is obtained, the next measuring point is aligned with the position to which the polarized light is applied by the ellipsometer 23 and a film thickness at the next measuring point is obtained. Then, this process is repeated, so that a film thickness at each of the measuring points is obtained in the step S15. A alignment of the substrate 9 may be achieved based on an image captured by an image capturing part which is additionally provided in the interferometer unit 24, which increases the accuracy in the alignment.

After film thicknesses at all the measuring points are obtained, the substrate 9 is taken out of the stage 21 by the transfer robot 25, and returned to the pod 91. In this manner, the substrate 9 is unloaded from the film-thickness measuring apparatus 1 (step S16).

All the processes for one of the substrates 9 are performed, the next one of the substrates 9 is prepared as a target of measurement. Then, the steps S11, S12, S13, S14, S15, and S16 are repeated (step S17). It is noted that actually the steps S12 and S14 are performed in parallel on different substrates 9, respectively, to allow the substrates to be efficiently processed in the organic contamination remover 3. The film-thickness measuring apparatus 1 ends processes with measurement of a thickness of a film on each of all the substrates 9 prepared as the targets of measurement, from which organic contamination has been removed (step S117).

As described above, in the organic contamination remover 3 of the film-thickness measuring apparatus 1 illustrated in FIG. 1, the hot plate 32, the cooling plate 33, and the transfer arm 34 are provided within the chamber body 31, and the substrate 9 is transferred from the hot plate 32 to the cooling plate 33 by the transfer arm 34 within the chamber body 31. Accordingly, it is possible to suppress re-adsorption of organic contamination onto the substrate 9 during a time period from a time when organic contamination adsorbed onto the substrate 9 is removed to a time when cooling of the substrate 9 is completed, in the organic contamination remover 3 which is capable of cooling one substrate while heating another substrate. As a result, a thickness of a thin film on the substrate 9 can be accurately measured in the film-thickness measuring apparatus 1. Also, since removal of organic contamination is achieved by heating the substrate 9 in the organic contamination remover 3, it is possible to remove organic contamination without degrading a quality of the substrate 9.

Next, a film-thickness measuring apparatus 1a according to a second preferred embodiment will be described. FIG. 6 illustrates a structure of the film-thickness measuring apparatus 1a. The film-thickness measuring apparatus 1a is different from the film-thickness measuring apparatus 1 according to the first preferred embodiment in that the transfer arm 34 in the organic contamination remover 3 is not provided and the openings 311 and 312 of the chamber body 31 are replaced by an opening 311a. The film-thickness measuring apparatus 1a is structurally identical to the film-thickness measuring apparatus 1 in all the other respects, and the same elements are denoted by the same reference numerals.

In an organic contamination remover 3a illustrated in FIG. 6, one opening 311a having a relatively large width along the Y direction is formed in a portion of a chamber body 31a closer to the body 2. Also, a shutter (not illustrated) for shutting the opening 311a and one nozzle 315a functioning as an air curtain while the opening 311a is opened are provided.

In removing organic contamination adsorbed onto the substrate 9 in the film-thickness measuring apparatus 1a (FIG. 5, step S12), the transfer robot 25 holding the substrate 9 moves a position facing the hot plate 32, and the shutter is opened. Thereafter, the arm 252 extends in the (−X) direction, so that the substrate 9 is transferred into the chamber body 31a through a portion on the (−Y) side of the opening 311a. Then, the substrate 9 is held by the plurality of lift pins 321. Subsequently, the lift pins 321 move downward, so that the substrate 9 is placed on the hot plate 32 and heated at a predetermined temperature for a predetermined time period.

After the substrate 9 is heated, the substrate 9 is moved upward by the plurality of lift pins 321 in the chamber body 31a, and the board 251 of the transfer robot 25 is located under the substrate 9. With the board 251 being located under the substrate 9, the lift pins 321 move downward, so that the substrate 9 is placed on the board 251. The transfer robot 25 moves in the (+Y) direction with the arm 252 being extending, and the substrate 9 is located above the cooling plate 33. Then, the substrate 9 is held by the plurality of lift pins 331, and subsequently is placed on the cooling plate 33 (step S13), to be cooled by the cooling plate 33 (step S14). After the substrate 9 is cooled, the substrate 9 is transferred to the outside of the chamber body 31a through a portion on the (+Y) side of the opening 311a. During the transfer from the cooling plate 33, the substrate 9 is further cooled by the nozzle 315a.

As described above, in the organic contamination remover 3a illustrated in FIG. 6, the substrate 9 is transferred from the hot plate 32 to the cooling plate 33 in the chamber body 31 by the transfer robot 25 provided externally to the chamber body 31a. Accordingly, it is possible to simplify the structure of the organic contamination remover 3a by not including the transfer arm 34, as well as to suppress re-adsorption of organic contamination onto the substrate 9 during a time period from a time when organic contamination adsorbed onto the substrate 9 is removed to a time when cooling of the substrate 9 is completed.

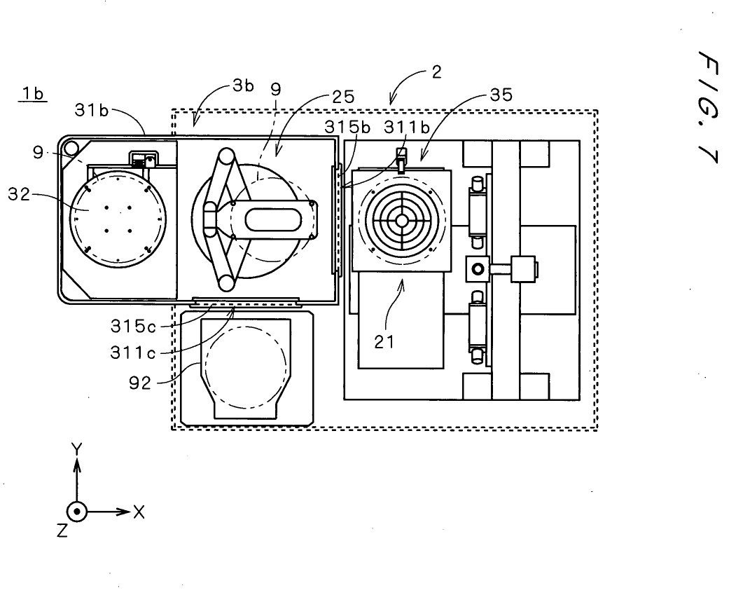

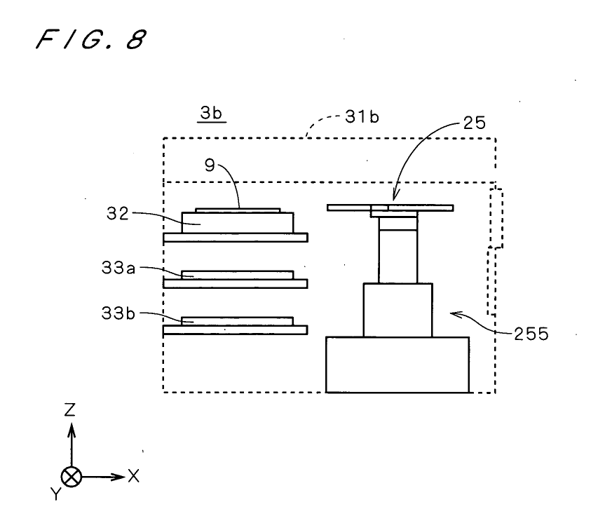

FIG. 7 illustrates an internal structure of a film-thickness measuring apparatus 1b according to a third preferred embodiment. FIG. 8 is a diagrammatic view of a structure of an organic contamination remover 3b of the film-thickness measuring apparatus 1b when viewed from the side thereof. In the following description, as the film-thickness measuring apparatus 1b is identical to the film-thickness measuring apparatus 1 illustrated in FIG. 2 in all the respects other than specifically indicated, the same elements are denoted by the same reference numerals.

In the film-thickness measuring apparatus 1b illustrated in FIG. 7, a chamber body 31b is provided so as to accommodate the transfer robot 25 in the organic contamination remover 3b, and an elevating mechanism 255 is attached to the transfer robot 25, in place of the moving mechanism 254 illustrated in FIG. 2, as illustrated in FIG. 8. In the chamber body 31b, one hot plate 32 and two cooling plates 33a and 33b are arranged along the Z direction. The transfer robot 25 has an access to each of the hot plate 32 and the cooling plates 33a and 33b. Further, openings 311b and 311c through which the substrate 9 is to pass are provided at portions on the (+X) side and the (−Y) side of the chamber body 31b, respectively, as illustrated in FIG. 7. The transfer robot 25 has an access to the stage 21 through the opening 311b and also has an access to an open cassette 92 provided in the body 2 through the opening 311c. Moreover, nozzles 315b and 315c each functioning as an air curtain are attached to the openings 311b and 311c, respectively.

In an upper part of the chamber body 31b illustrated in FIG. 8, exhaust pipes connected to an exhaust pump are provided in the same manner as in the organic contamination remover 3 illustrated in FIG. 3. Also, in the organic contamination remover 3b, the hot plate 32 is located at the highest level, and a heated air moves upward to be let out through the exhaust pipes. Accordingly, cooling of the substrate 9 by the cooling plates 33a and 33b located at lower levels is prevented from being affected by heat given out from the hot plate 32. Additionally, the centering unit 35 is provided in the stage 21 in the film-thickness measuring apparatus 1b.

In cooling the substrate 9 in the film-thickness measuring apparatus 1b, the substrate 9 is transferred from the hot plate 32 to the cooling plate 33a located at the middle level (step S13) after the substrate 9 is heated by the hot plate 32 (FIG. 5, step S12). On the cooling plate 33a, the substrate 9 is cooled to reduce a temperature of the substrate 9 to 30 to 60° C., for example (step S14). Then, after a predetermined time period passes, the substrate 9 is transferred to the cooling plate 33b at the lowest level. On the cooling plate 33b, the substrate 9 is cooled to reduce the temperature of the substrate 9 to 10 to 40° C. (step S14). While the substrate 9 is being cooled on the cooling plate 33b, the next substrate 9 which has been heated is placed on the cooling plate 33a. In this manner, cooling is performed on two substrates 9 in parallel.

As described above, in the film-thickness measuring apparatus 1b illustrated in FIG. 7, the hot plate 32 and the cooling plates 33a and 33b each in a horizontal state are vertically arranged. This can reduce a footprint of the film-thickness measuring apparatus 1b. Also, a transfer path of the substrate 9 from the hot plate 32 to the cooling plate 33a and a transfer path from the cooling plate 33a to the cooling plate 33b is provided in the chamber body 31b. Hence, it is possible to suppress re-adsorption of organic contamination onto the substrate 9 during a time period from a time when organic contamination adsorbed onto the substrate 9 is removed to a time when cooling of the substrate 9 is completed. Further, provision of the plurality of cooling plates 33a and 33b adds a buffering function in cooling of the substrate 9 in the step S14 which takes a longer time than heating of the substrate 9 in the step S12, to the film-thickness measuring apparatus 1b. As a result, a plurality of substrates can be cooled in parallel, to improve the capability of removing organic contamination of the organic contamination remover 3b. It is noted that one substrate 9 is not necessarily required to be cooled in stages using the cooling plates 33a and 33b. Alternatively, one substrate 9 may be cooled using only one of the cooling plates 33a and 33b.

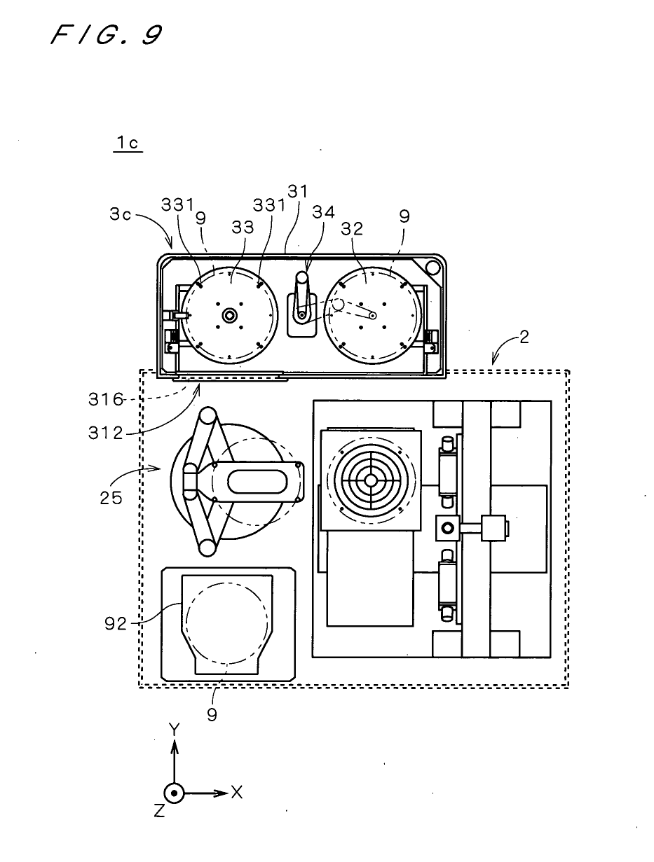

FIG. 9 illustrates an internal structure of a film-thickness measuring apparatus 1c according to a fourth preferred embodiment. In the following description, as the film-thickness measuring apparatus 1c is identical to the film-thickness measuring apparatus 1 illustrated in FIG. 2 in all the respects other than specifically indicated, the same elements are denoted by the same reference numerals.

In the film-thickness measuring apparatus 1c, an organic contamination remover 3c is provided in the (+Y) direction relative to the body 2, and the hot plate 32 and the cooling plate 33 are provided on the (+X) side and the (−X) side in the chamber body 31, respectively. Also, the opening 312 which is opened and closed by a shutter (not illustrated) is provided in a portion on the (−Y) side (i.e., a portion closer to the body 2) of the chamber body 31. The opening 312 is located in the vicinity of the cooling plate 33. Further, the nozzle 316 for forming an air curtain when the opening 312 is opened is provided.

The film-thickness measuring apparatus 1c does not include the opening 311 and the nozzle 315 which are provided in the vicinity of the hot plate 32 in the structure in FIG. 3, one of the two exhaust pipes 318 which is located in the vicinity of the cooling plate 33 in the structure in FIG. 4, and the moving mechanism 254 for moving the transfer robot 25 in the Y direction in the structure in FIG. 1. In the film-thickness measuring apparatus 1c, the open cassette 92 for housing the substrate 9 is provided in the (−Y) direction relative to the transfer robot 25 as illustrated in FIG. 9.

In removing organic contamination adsorbed onto the substrate 9 in the film-thickness measuring apparatus 1c (FIG. 5, step S12), the substrate 9 is transferred into the chamber body 31 through the opening 312 by the transfer robot 25, and then is held by the lift pins 331 of the cooling plate 33 which have previously moved upward. Subsequently, the substrate 9 is transferred from the cooling plate 33 to the hot plate 32 by the transfer arm 34, and heated on the hot plate 32 at a predetermined temperature for a predetermined time period.

After the substrate 9 is heated, the substrate 9 is again transferred from the hot plate 32 to the cooling plate 33 in the chamber body 31 (step S13), and cooled by the cooling plate 33 (step S14). After the substrate 9 is cooled, the substrate 9 is transferred from the cooling plate 33 to the outside of the chamber body 31 through the opening 312. During the transfer from the cooling plate 33, the substrate 9 is further cooled by the nozzle 316.

As described above, in the film-thickness measuring apparatus 1c according to the fourth preferred embodiment, the chamber body 31 includes only the opening 312 through which the substrate 9 is to pass, and the substrate 9 is once received by the cooling plate 33 when it is transferred from and to the chamber body 31. Accordingly, the size of the shutter provided for opening and closing the opening of the chamber body 31 can be reduced. The size reduction of the shutter and omission of the moving mechanism of the transfer robot 25 can simplify the structure of the film-thickness measuring apparatus, as well as to suppress re-adsorption of organic contamination onto the substrate 9 during a time period from a time when an organic contamination adsorbed onto the substrate 9 is removed to a time when cooling of the substrate 9 is completed.

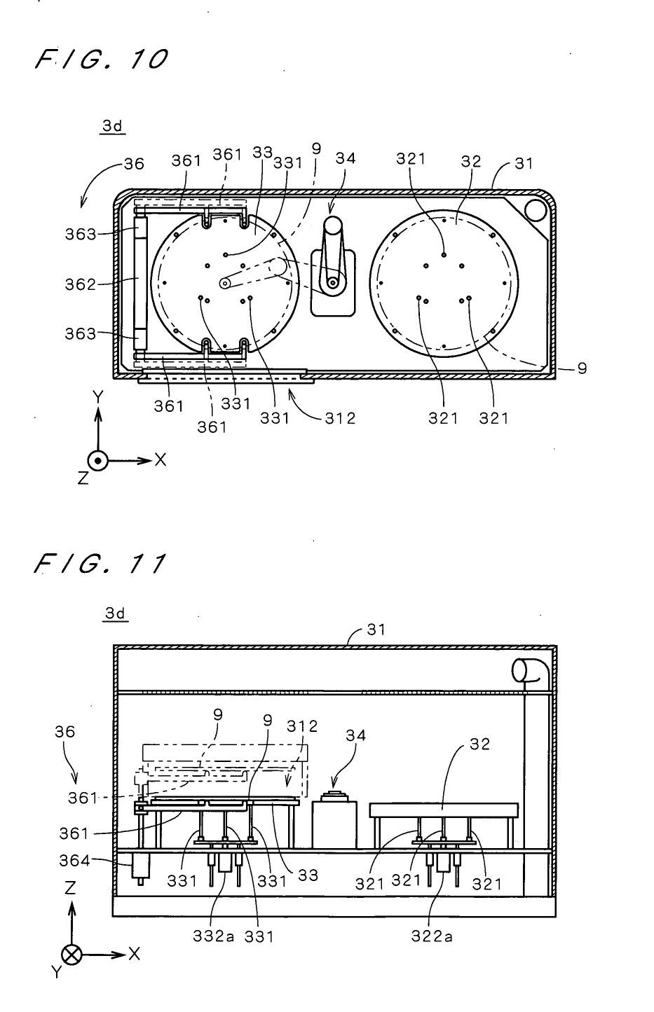

FIGS. 10 and 11 illustrate an internal structure of an organic contamination remover 3d of a film-thickness measuring apparatus according to a fifth preferred embodiment. In the following description, as the organic contamination remover 3d is identical to the organic contamination remover 3c of the film-thickness measuring apparatus 1c illustrated in FIG. 9 in all the respects other than specifically indicated, the same elements are denoted by the same reference numerals.

The organic contamination remover 3d does not include the centering unit 35 (see FIG. 4) of the cooling plate 33, and the plurality of lift pins 331 are located closer to a center of the cooling plate 33 than those illustrated in FIG. 9. Also, a pin moving mechanism 332a (see FIG. 11) for moving the lift pins 331 in the Z direction is provided in the (−Z) direction relative to the lift pins 331. Further, the lift pins 321 and a pin moving mechanism 322a of the hot plate 32 are provided in the same manner as the lift pins 33a and the pin moving mechanism 332a of the cooling plate 33.

The organic contamination remover 3d includes a substrate withdrawal mechanism 36 for receiving the substrate 9 placed on the cooling plate 33 and withdrawing the substrate 9 from the cooling plate 33 in the chamber body 31. As illustrated in FIG. 10, the substrate withdrawal mechanism 36 includes two retainers 361 which are provided in the (+Y) direction and the (−Y) direction relative to the cooling plate 33, respectively, so as to face each other and function to retain the back surface of the substrate 9, a supporting part 362 for supporting the retainers 361, and a distance changing mechanism 363 for changing a distance between the two retainers 361 along the Y direction. Moreover, the substrate withdrawal mechanism 36 further includes a retainer elevating mechanism 364 for moving the retainers 361 in the Z direction.

In the substrate withdrawal mechanism 36, the two retainers 361 which are located in positions indicated by solid lines in FIG. 11 are moved from positions indicated by double-dashed lines in FIG. 10 to positions indicated by solid lines in FIG. 10 by the distance changing mechanism 363 illustrated in FIG. 10. As a result, respective parts of the retainers 361 are located in the (−Z) direction relative to the substrate 9 which is placed on the cooling plate 33. Then, the retainers 361 are moved upward by the retainer elevating mechanism 364 to receive the substrate 9 from the cooling plate 33 and retain the substrate 9. Subsequently, the retainers 361 are moved upward to positions indicated by double-dashed lines in FIG. 11, to withdraw the substrate 9 from the cooling plate 33. In the following description, each of the respective positions of the retainers 361 and the substrate 9 which are indicated by solid lines in FIG. 11 will be referred to as an “acceptance position”, and each of the respective positions of the retainers 361 and the substrate 9 which are indicated by double-dashed lines in FIG. 11 will be referred to as a “standby position”. Also, each of the respective positions of the retainers 361 which are indicated by solid lines in FIG. 10 will be referred to as a “close position”, and each of the respective positions of the retainers 361 which are indicated by double-dashed lines in FIG. 10 will be referred to as an “open position”.

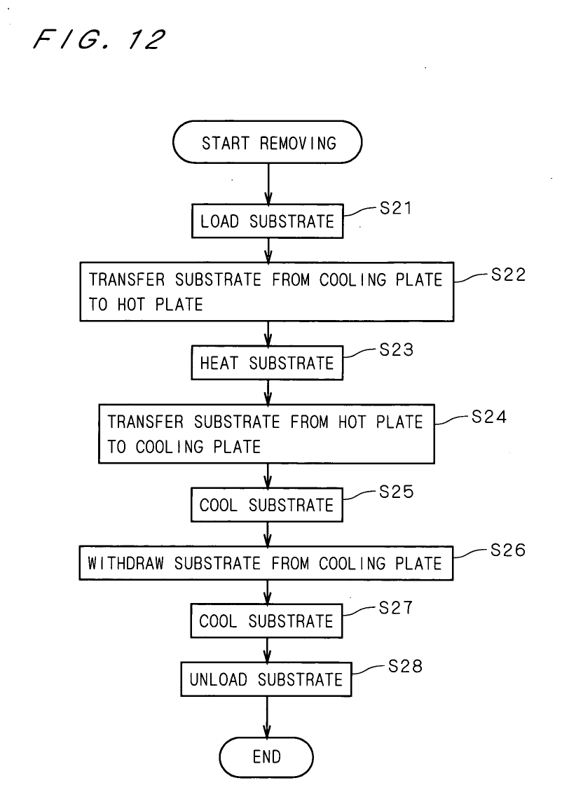

FIG. 12 is a flow chart illustrating operations for removing organic contamination adsorbed onto one of the substrates 9, which are performed by the organic contamination remover 3d of the film-thickness measuring apparatus according to the fifth preferred embodiment. For removal of organic contamination by the organic contamination remover 3d, first, the substrate 9 is transferred into the chamber body 31 through the opening 312, and subsequently is held by the lift pins 331 of the cooling plate 33 which have previously been moved upward by the pin moving mechanism 332 (step S21). Then, the substrate 9 is transferred from the cooling plate 33 to the hot plate 32 by the transfer arm 34 in the chamber body 31 (step S22), and is heated on the hot plate 32 at a predetermined temperature for a predetermined time period (step S23).

After the substrate 9 is heated, the substrate 9 is again transferred from the hot plate 32 to the cooling plate 33 by the transfer arm 34 in the chamber body 31 (step S24), and placed on the cooling plate 33 for a predetermined time period to be cooled (for example, the temperature of the substrate is reduced to 40 to 60° C.) (step S25). Subsequently, the retainers 361 of the substrate withdrawal mechanism 36 which have been closed in the acceptance positions are moved upward to the standby positions by the retainer elevating mechanism 364, and withdraw the substrate 9 from the cooling plate 33 (step S26). Then, the substrate 9 is retained in the standby position by the retainers 361 to be cooled (for example, the temperature of the substrate 9 is reduced to 10 to 40° C.) (step S27). After the substrate 9 is cooled, the substrate 9 is received by the transfer robot 25 (see FIG. 9) from the retainers 361, and transferred to the outside of the chamber body 31 through the opening 312. In this manner, removal of organic contamination for one of the substrates 9 is completed (step S28). In the following description, cooling of the substrate 9 in the step S25 and cooling of the substrate 9 in the step S27 will be referred to as “first cooling” and “second cooling”, respectively.

In the organic contamination remover 3d, while second cooling of one substrate 9 located in the standby position illustrated in FIG. 4 is being performed, the next substrate 9 is transferred into the chamber body 31, and is transferred from the cooling plate 33 to the hot plate 32 to be heated. The next substrate is again transferred to the cooling plate 33, and first cooling of the next substrate 9 is performed (steps S21, S22, S23, S24, and S25). Then, when the substrate 9 which has been subjected to second cooling in the standby position is transferred from the chamber body 31, the retainers 361 which have been located in the standby positions are moved from the close positions to the open positions by the distance changing mechanism 363. Thereafter, the retainers 361 are moved from the standby positions to the acceptance positions by the retainer elevating mechanism 364. Then, with being located in the acceptance positions, the retainers 361 are moved from the open positions to the close positions, to be located in the (−Z) direction relative to the next substrate 9 placed on the cooling plate 33′. After that, the retainers 361 are moved upward by the retainer elevating mechanism 364 so that the next substrate 9 is withdrawn from the cooling plate 33 to be located in the standby position. Then, second cooling of the next substrate 9 is performed, and transferred from the chamber body 31 (steps S26, S27, and S28).

As described above, in the film-thickness measuring apparatus according to the fifth preferred embodiment, cooling of the substrate 9 in the organic contamination remover 3d is performed in two stages. Since the substrate 9 is withdrawn from the cooling plate 33 during second cooling thereof, removal of organic contamination for a plurality of substrates can be performed partly in parallel. Accordingly, an average time period required to remove organic contamination for one substrate can be shortened. In other words, the substrate withdrawal mechanism 36 functions as a buffer in cooling which takes a longer time than heating (especially in the case where natural heat dissipation is utilized for cooling in order to save costs associated with cooling as in the fifth preferred embodiment). Accordingly, operations for removing organic contamination can be efficiently performed. Also, it is possible to simplify the structure of the organic contamination remover, as well as to suppress re-adsorption of organic contamination onto the substrate 9 during a time period from a time when organic contamination adsorbed onto the substrate 9 is removed to a time when cooling is completed in the same manner as in the case illustrated in FIG. 9.

Hereinbefore, though the preferred embodiments of the present invention have been described, the present invention is not limited to the above-described preferred embodiments, and various modifications are possible.

For example, for housing the substrates 9 in the film-thickness measuring apparatus, various container other than the pod 91 such as a FOUP illustrated in FIG. 2 and the open cassette 92 illustrated in FIG. 7, may be employed. Also, a plurality of FOUPs for housing the substrates 9 (for example, a FOUP dedicated to loading and a FOUP dedicated to unloading) may be provided. In this case, moving mechanisms which move the transfer robot 25 and have accesses to the plurality of FOUPs, respectively, are provided as needed.

According to the above-described preferred embodiments, the substrate 9 is moved relative to the cooling plate 33 by the centering unit 35 in order to adjust the location of the substrate 9. Alternatively, the location of the substrate 9 may be adjusted relative to the transfer robot 25 by slightly moving the cooling plate 33 on which the substrate 9 is placed, for example.

The substrate 9 is not limited to a semiconductor substrate. Alternatively, the substrate 9 may be a glass substrate used for a liquid crystal display, a flat panel display, or the like.

While the invention has been shown and described in detail, the foregoing description is in all aspects illustrative and not restrictive. It is therefore understood that numerous modifications and variations can be devised without departing from the scope of the invention.

This application claims priority benefit under 35 U.S.C. Section 119 of Japanese Patent Application No. 2004-66528 and Japanese Patent Application No. 2004-122416 filed in the Japanese Patent Office on Mar. 10, 2004 and Apr. 19, 2004, the entire disclosure of which is incorporated herein by reference.

1. An apparatus for removing organic contamination adsorbed onto a substrate, comprising:
a hot plate for heating a substrate;
a cooling plate for cooling said substrate;
a transfer mechanism for moving a substrate from said hot plate to said cooling plate; and
a chamber body in which said hot plate and said cooling plate are provided, said chamber body including a transfer path of a substrate from said hot plate to said cooling plate.

2. The apparatus according to claim 1, wherein
said hot plate and said cooling plate each in a horizontal state are arranged along a horizontal direction.

3. The apparatus according to claim 1, wherein
said transfer mechanism is provided in said chamber body.

4. The apparatus according to claim 3, wherein
said chamber body comprises only one opening through which a substrate passes, and said substrate is once received by said cooling plate when said substrate is transferred to and from said chamber body.

5. The apparatus according to claim 1, wherein
said chamber body comprises:
an opening through which a substrate passes when transferred to said hot plate; and
another opening through which a substrate passes when transferred from said cooling plate.

6. The apparatus according to claim 5, wherein
said chamber body further comprises a nozzle for ejecting gas toward a substrate passing through said another opening.

7. The apparatus according to claim 1, wherein
said chamber body comprises:
an opening through which a substrate passes; and
a nozzle for ejecting gas along a face in which said opening is formed.

8. The apparatus according to claim 1, further comprising
a mechanism for receiving a substrate from said cooling plate and withdrawing said substrate in said chamber body.

9. The apparatus according to claim 1, further comprising
a mechanism for exhausting gas within said chamber body.

10. An apparatus for measuring a thickness of a thin film formed on a substrate, comprising:
an organic contamination remover for removing organic contamination adsorbed onto a substrate; and
a film-thickness measuring part for measuring a film thickness on a substrate after organic contamination is removed from said substrate by said organic contamination remover, wherein
said organic contamination remover comprises:
a hot plate for heating a substrate;
a cooling plate for cooling said substrate;
a transfer mechanism for moving a substrate from said hot plate to said cooling plate; and
a chamber body in which said hot plate and said cooling plate are provided, said chamber body including a transfer path of a substrate from said hot plate to said cooling plate.

11. The apparatus according to claim 10, wherein
said film-thickness measuring part comprises an ellipsometer.

12. The apparatus according to claim 10, wherein
said cooling plate of said organic contamination remover comprises a mechanism for adjusting a location of a substrate.

13. The apparatus according to claim 10, wherein
said hot plate and said cooling plate each in a horizontal state are arranged along a horizontal direction.

14. The apparatus according to claim 10, wherein
said transfer mechanism is provided in said chamber body.

15. The apparatus according to claim 14, wherein
said chamber body comprises only one opening through which a substrate passes, and
said substrate is once received by said cooling plate when said substrate is transferred to and from said chamber body.

16. The apparatus according to claim 10, wherein
said chamber body comprises:
an opening through which a substrate passes when transferred to said hot plate; and
another opening through which a substrate passes when transferred from said cooling plate.

17. The apparatus according to claim 10, wherein
said organic contamination remover comprises a mechanism for receiving a substrate from said cooling plate and withdrawing said substrate in said chamber body.

18. A method of removing organic contamination adsorbed onto a substrate, comprising the steps of:
a) transferring a substrate into a chamber body;
b) heating said substrate on said hot plate provided in said chamber body;
c) moving said substrate from said hot plate to said cooling plate provided in said chamber body along a transfer path in said chamber body;
d) cooling said substrate on said cooling plate; and
e) transferring said substrate from said chamber body.

19. The method according to claim 18, wherein
said hot plate and said cooling plate each in a horizontal state are arranged along a horizontal direction.

20. The method according to claim 18, wherein
in said step a), said substrate is transferred to said hot plate through an opening provided in said chamber body, and
in said step e), said substrate is transferred from said cooling plate through another opening provided in said chamber body.

21. The method according to claim 18, wherein
in said step a), said substrate is transferred to said cooling plate through an opening provided in said chamber body, and is transferred from said cooling plate to said hot plate, and
in said step e), said substrate is transferred from said cooling plate through said opening.

22. The method according to claim 21, further comprising the step of
f) withdrawing said substrate from said cooling plate in said chamber body between said steps d) and e), wherein
said step a) is performed on a next substrate in parallel with said step f).

23. A method of measuring a thickness of a thin film formed on a substrate, comprising the steps of:
a) transferring a substrate into a chamber body;
b) heating said substrate on a hot plate provided in said chamber body;
c) moving said substrate from said hot plate to a cooling plate provided in said chamber body along a transfer path in said chamber body;
d) cooling said substrate on said cooling plate;
e) transferring said substrate from said chamber body; and
f) measuring a thickness of a thin film formed on said substrate.

24. The method according to claim 23, wherein
in said step f), a thickness of a thin film is measured by an ellipsometer.

25. The method according to claim 23, wherein
said hot plate and said cooling plate each in a horizontal state are arranged along a horizontal direction.

26. The method according to claim 23, wherein
in said step a), said substrate is transferred to said hot plate through an opening provided in said chamber body, and
in said step e), said substrate is transferred from said cooling plate through another opening provided in said chamber body.

27. The method according to claim 23, wherein
in said step a), said substrate is transferred to said cooling plate through an opening provided in said chamber body, and is transferred from said cooling plate to said hot plate, and
in said step e), said substrate is transferred from said cooling plate through said opening.

28. The method according to claim 27, further comprising the step of g) withdrawing said substrate from said cooling plate in said chamber body between said steps d) and e), wherein
said step a) is performed on a next substrate in parallel with said step g).
